(19) United States
(12) Patent Application Publication
(10) Pub. No.: US 2025/0157270 A1
(43) Pub. Date: May 15, 2025

(54) VEHICLE STATUS MONITORING SYSTEM AND METHOD

(71) Applicant: HL MANDO CORPORATION, Gyeonggi-do (KR)

(72) Inventor: Soo Hyun KO, Gyeonggi-do (KR)

(21) Appl. No.: 18/946,852

(22) Filed: Nov. 13, 2024

(30) Foreign Application Priority Data
Nov. 13, 2023 (KR) 10-2023-0156584

(51) Int. Cl. G07C 5/08; G07C 5/00

(52) U.S. Cl. CPC G07C 5/0808; G07C 5/008

(57) ABSTRACT

A vehicle status monitoring method is disclosed. The vehicle status monitoring method according to one embodiment of the present disclosure comprises: receiving status information data; determining whether a status information collection device is operating normally or abnormally; and outputting a result of judging vehicle status information using the status information data when it is determined that the status information collection device is operating normally, and transmitting the status information data to an outside when it is determined that the status information collection device is operating abnormally.

### CROSS REFERENCE TO RELATED APPLICATION

This application claims the benefit of and priority to Korean Patent Application No. 10-2023-0156584, filed on Nov. 13, 2023, which is incorporated by reference herein in its entirety.

### BACKGROUND

### Technical Field

The present disclosure relates to a vehicle status monitoring system and method, and more specifically, to a vehicle status monitoring system and method capable of continuously performing a vehicle status monitoring function even when an abnormality occurs in a status information collection device mounted on a vehicle while collecting status data using the status information collection device and determining whether an abnormality has occurred using the collected status data.

### Related Art

General vehicle fault diagnosis is done by lighting a warning light on a dashboard when a problem occurs in a vehicle to let a user know that there is a problem and to have it inspected. Mechanics connect a scanning device to an OBD (On-Board Diagnostics) terminal and analyze diagnostic trouble codes (DTCs) to determine if any sensors or components in the vehicle are malfunctioning.

However, as the functions and components of recently released vehicles become more advanced, the traditional fault diagnosis method has limitations in detecting faults caused by complex causes among various components and sensors that make up a vehicle in real time.

Considering the above situation, attempts are being made to install status information collection devices that collect onboard data or sensor data inside the vehicle and use them to monitor the occurrence of faults in real time or to predict the occurrence of faults in advance.

However, if a fault occurs in the status information collection device itself, it would be impossible to detect whether there is an abnormality in the vehicle even when onboard data or sensor data are received normally. Accordingly, a need has arisen for a method capable of continuously performing the function of judging status information of a vehicle even if there is a failure in the status information collection device equipped in the vehicle.

### PRIOR ART DOCUMENT

### Patent Document

Korean Patent No. 10-2437043(Aug. 23, 2022)

### SUMMARY

In view of the above, the present disclosure provides a vehicle status monitoring system and method capable of continuously performing a vehicle status judgment function even when a status information collection device equipped in a vehicle has a failure.

In addition, the present disclosure provides a vehicle status monitoring system and method capable of preventing accidents caused by vehicle failure in advance through rapid and accurate failure detection.

The objectives of the present disclosure are not limited to those mentioned above, and other objectives not mentioned will be clearly understood by those skilled in the art from the following description.

A vehicle status monitoring method, in accordance with one embodiment of the present disclosure, comprises: receiving status information data; determining whether a status information collection device is operating normally or abnormally; and outputting a result of judging status information of a vehicle using the status information data when it is determined that the status information collection device is operating normally, and transmitting the status information data to an outside when it is determined that the status information collection device is operating abnormally.

In accordance with one embodiment of the present disclosure, the receiving of the status information data may include receiving at least one of component status information data and sensing data collected while the vehicle is driving.

In accordance with one embodiment of the present disclosure, the vehicle status monitoring method may further comprise transmitting the status information data to the outside and receiving status information of a vehicle from the outside when it is determined that the status collection device is operating abnormally.

In accordance with one embodiment of the present disclosure, the transmitting of the status information data to the outside when it is determined that the status collection device is operating abnormally, may include: receiving at least one of a status information data request signal and a vehicle status information judgment operation control signal from the outside; and transmitting the status information data to the outside.

In accordance with one embodiment of the present disclosure, the vehicle status monitoring method may further comprise stopping an operation of judging the status information of the vehicle.

In accordance with one embodiment of the present disclosure, the transmitting of the status information data to the outside when it is determined that the status collection device is operating abnormally, may include stopping an operation of judging the status information of the vehicle and transmitting the status information data to the outside when a preset error occurs in the status information collection device or when a voltage or current applied to the status information collection device is out of a preset range.

In a vehicle status monitoring system including a status information collection device and a central control device equipped in a vehicle, in accordance with another embodiment of the present disclosure, the status information collection device outputs a result of judging status information of the vehicle based on status information data of the vehicle when the condition information collection device is normal, and the central control device outputs a result of judging status information of the vehicle based on the status information data of the vehicle when the status information collection device is abnormal.

In accordance with one embodiment of the present disclosure, the central control device may transmit a status information data request signal and a vehicle status information judgment operation control signal to the status information collection device when the status information collection device is abnormal.

In accordance with one embodiment of the present disclosure, the vehicle status information judgment operation control signal may be a control signal to stop an operation of judging the status information of the vehicle.

In accordance with one embodiment of the present disclosure, the central control device may transmit a status confirmation signal to the status information collection device, and determine that a failure has occurred in the status information collection device when a confirmation response signal is not received from the status information collection device within a preset time or when a confirmation response signal is not received even after transmitting the status confirmation signal more than a preset number of times.

In accordance with one embodiment of the present disclosure, the central control device may determine that a failure has occurred in the status information collection device when the vehicle status information judged by the status information collection device and the vehicle status information judged by the central control device are different.

In accordance with one embodiment of the present disclosure, the central control device may determine a status of the vehicle based on the vehicle status information judged by the central control device when the vehicle status information judged by the status information collection device is different from the vehicle status information judged by the central control device.

In accordance with one embodiment of the present disclosure, the central control device may transmit the vehicle status information judged by the central control device to the status information collection device.

In accordance with one embodiment of the present disclosure, the status information collection device may transmit the status information data to the central control device when a preset error code occurs and stop the vehicle status information judgment operation.

In accordance with one embodiment of the present disclosure, when a voltage or current applied to the status information collection device is out of a preset range, the status information collection device may transmit the status information data to the central control device and stop the vehicle status information judgment operation.

According to the vehicle status monitoring system and method described above, it is possible to ensure continuity of the monitoring function even when an abnormality occurs in the status information collection device installed in the vehicle and the vehicle status cannot be monitored in real time.

### BRIEF DESCRIPTION OF THE DRAWINGS

FIG. 1 is a diagram for explaining a vehicle status monitoring system according to one embodiment of the present disclosure.

FIGS. 2 and 3 are diagrams for explaining connection examples of the status information collection device according to one embodiment of the present disclosure.

FIG. 4 is a flowchart for explaining a vehicle status monitoring method according to one embodiment of the present disclosure.

FIG. 5 is a diagram for explaining a method for determining whether a failure has occurred in the status information collection device according to one embodiment of the present disclosure.

FIG. 6 is a diagram for explaining a method for determining whether a failure has occurred in the status information collection device according to another embodiment of the present disclosure.

FIG. 7 is a diagram for explaining a method for determining whether a failure has occurred in the status information collection device according to still another embodiment of the present disclosure.

### DETAILED DESCRIPTION

Hereinafter, preferred embodiments of the present disclosure will be described in detail with reference to the accompanying drawings. The advantages and features of the present disclosure and the methods for achieving them will become apparent by referring to the embodiments described in detail below in conjunction with the accompanying drawings. However, the technical idea of the present disclosure is not limited to the following embodiments but may be implemented in various different forms, and the following embodiments are provided only to make the technical idea of the present disclosure complete and to make the scope of the present disclosure fully known to a person having ordinary skill in the art to which the present disclosure pertains, and the technical idea of the present disclosure is defined only by the scope of the claims.

It should be noted that in assigning reference numerals to components in each drawing, the same components are given the same reference numerals as much as possible even when they are shown in different drawings. In addition, in describing the present disclosure, if it is determined that a detailed description of a related known configuration or function may obscure the gist of the present disclosure, the detailed description will be omitted.

Unless otherwise defined, all terms (including technical and scientific terms) used in the present specification may be used in the meaning that can be commonly understood by a person of ordinary skill in the art to which the present disclosure pertains. In addition, terms defined in commonly used dictionaries are not to be ideally or excessively interpreted unless explicitly defined otherwise. The terms used in the present specification are for the purpose of describing embodiments and are not intended to limit the present disclosure. In the present specification, the singular also includes the plural unless specifically stated in the phrase.

In describing components of the embodiment according to the present disclosure, designations such as first, second, A, B, (a), (b), and the like may be used. These designations are only used to distinguish the component from other components, and the nature, order, or sequence of the component is not limited by the designations. When a component is described as being “connected,” “coupled,” or “linked” to another component, it should be understood that the component may be directly connected, coupled or linked to another component, but that there may also be other components “connected,” “coupled,” or “linked” between them.

As used herein, the terms “comprise” and/or “comprising” do not exclude the presence or addition of one or more other components, steps, operations and/or elements.

Hereinafter, various embodiments of the present disclosure will be described in detail with reference to the accompanying drawings.

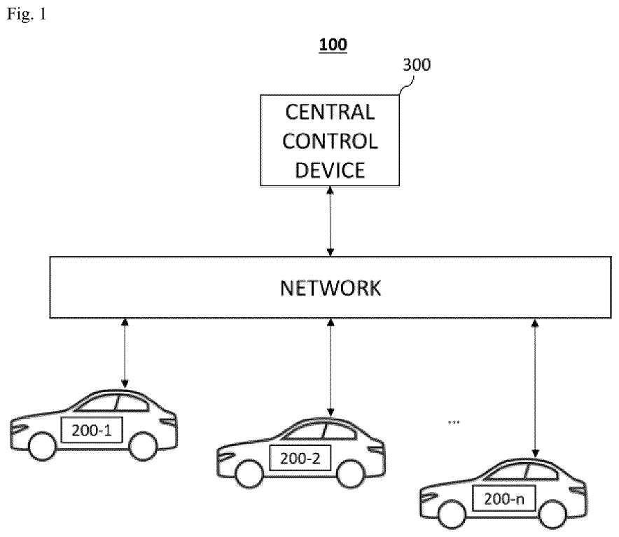

FIG. 1 is a diagram for explaining a vehicle status monitoring system according to one embodiment of the present disclosure.

A vehicle status monitoring system 100 according to one embodiment of the present disclosure includes at least one status information collection device 200-1, 200-2, . . . , 200-n and a central control device 300.

Only the components related to the embodiment of the present disclosure are illustrated in FIG. 1, and a person of ordinary skill in the art to which the present disclosure pertains will understand that other components may be included in addition to the components illustrated in FIG. 1.

The status information collection device 200-1, 200-2, . . . , 200-n is installed in a vehicle to collect status information data of the vehicle and judge status information of the vehicle.

The status information data includes component status information data or sensing data collected from sensors installed in the vehicle.

In one embodiment of the present disclosure, the component status information data may include status information of consumable items that require periodic replacement, such as engine oil level, brake pad, coolant, brake oil level, battery, or the status information of other general components.

The sensing data may be data received from various sensors installed in the vehicle while the vehicle is driving or stopped.

In one embodiment of the present disclosure, the sensing data may include data sensed while the vehicle is driving, such as fuel injection amount, fuel temperature, intake air amount, intake air temperature, atmospheric pressure, coolant temperature, brake pedal position, accelerator pedal position, air conditioner switch, cooling fan, vehicle speed, acceleration, engine RPM, engine load, engine output torque, etc.

The aforementioned component status information data and sensing data are exemplary, and the data that may be included therein are not limited to those described, and other data may be further included.

When the status information collection device 200-1, 200-2, . . . , 200-n is determined to be capable of performing an abnormality determination operation through self-diagnosis, it judges the status information of the vehicle using the collected status information data. Here, the case where the abnormality determination operation can be performed means that the status information collection device 200-1, 200-2, . . . , 200-n itself is not malfunctioning, and thus the status information of the vehicle can be judged using the collected status information data.

The status information collection device 200-1, 200-2, . . . , 200-n generates a fault code corresponding to the occurrence of an abnormal event if at least one of the data included in the status information data is determined to be abnormal. Optionally, additional pre-actions may be executed in response to detection of the abnormal event. In this case, the additional pre-actions may be any one of turning on a warning light, outputting a warning message, starting a maintenance operation, and initializing the system.

If an abnormal event occurrence is detected but a corresponding fault code is not already stored, the status information collection device 200-1, 200-2, . . . , 200-n may calculate and output the type and occurrence probability of the fault.

The status information collection device 200-1, 200-2, . . . , 200-n may transmit the result of judging the vehicle status information using the status information data to the central control device 300. In other words, the judgment of the vehicle status information using the data collected from the vehicle is performed in the status information collection device 200-1, 200-2, . . . , 200-n, and only the judgment result is transmitted to the central control device 300.

Meanwhile, there may be cases where the status information collection device 200-1, 200-2, . . . , 200-n itself is malfunctioning, making it impossible to judge the vehicle status information or resulting in inaccurate judgment.

If the status information collection device 200-1, 200-2, . . . , 200-n determines through self-diagnosis that it cannot perform the vehicle status judgment operation, it transmits the collected status information data to the central control device 300.

In this case, the judgment of the vehicle status information using the data collected from the vehicle is performed in the central control device 300, and the status information collection device 200-1, 200-2, . . . , 200-n receives only the judgment results. That is, the status information collection device 200-1, 200-2, . . . , 200-n may receive only an abnormal event occurrence detection signal or only fault code information corresponding to the abnormal event occurrence. Alternatively, the status information collection device 200-1, 200-2, . . . , 200-n may receive only a pre-action execution command corresponding to the abnormal event detection. The pre-action execution command may be any one of a warning light turning on, a warning message output, a maintenance operation start, and a system initialization command.

According to the vehicle status monitoring system described above, it is possible to ensure continuity of the monitoring function even when an abnormality occurs in the status information collection device installed in the vehicle and the vehicle status cannot be monitored in real time.

Hereinafter, specific implementation examples of the status information collection device 200-1, 200-2, . . . , 200-n and conditions for switching the subject judging the vehicle status information from the status information collection device 200-1, 200-2, . . . , 200-n to the central control device 300 are described in detail.

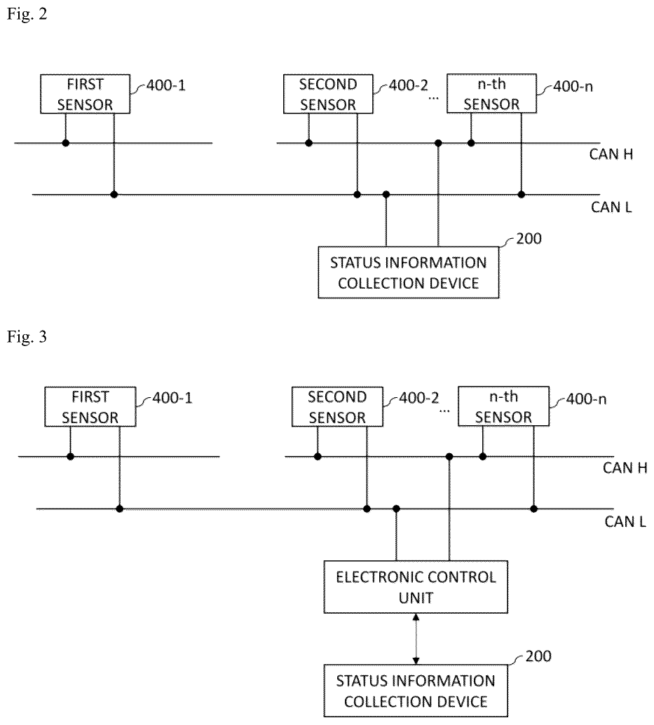

FIGS. 2 and 3 are diagrams for explaining connection examples of a status information collection device 200 according to one embodiment of the present disclosure.

As illustrated in FIG. 2, the status information collection device 200 according to one embodiment of the present disclosure may be implemented in the form of an electronic control unit (ECU) interconnected with a plurality of sensors 400-1, 400-2, . . . , 400-n through a controller area network (CAN).

In this case, the electronic control unit may be any one of modules that are physically or logically separated and perform individual functions, such as an airbag control unit (ACU), an engine control unit (ECU), a transmission control unit (TCU), a brake control unit (BCU), and on-board diagnostics (OBD), etc.

In other words, the status information collection device 200 according to one embodiment of the present disclosure may be implemented in the form of an electronic control unit that is typically included in a vehicle and performs an independent function. In this case, a program for collecting status information and judging the status of the vehicle may be installed on the electronic control unit.

In FIG. 2, individual sensors 400-1, 400-2, . . . , 400-n are physically separated and connected to the CAN as an example. However, the sensors may be implemented in a form in which they are included in the electronic control unit module described above and the plurality of electronic control unit modules are connected to the CAN.

Meanwhile, the status information collection device 200 according to another embodiment of the present disclosure may be implemented in a separate hardware form that is physically separated from the electronic control unit as shown in FIG. 3.

Specifically, the electronic control unit connected to the individual sensors 400-1, 400-2, . . . , 400-n through the CAN may collect status information data and the status information collection device 200 may receive them.

In FIG. 3, for convenience of explanation, an example is illustrated in which one electronic control unit collects status information data from multiple sensors 400-1, 400-2, . . . , 400-n and transmits them to the status information collection device 200. However, it is also possible to implement a structure where multiple electronic control units collect status information data from multiple sensors 400-1, 400-2, . . . , 400-n and transmit them to the status information collection device 200.

In addition, although FIG. 3 illustrates that the electronic control unit and the status information collection device 200 transmit and receive data through a separate network, the status information collection device may also be implemented in a form in which it is connected to the CAN network and receives status information data from the electronic control unit through CAN communication.

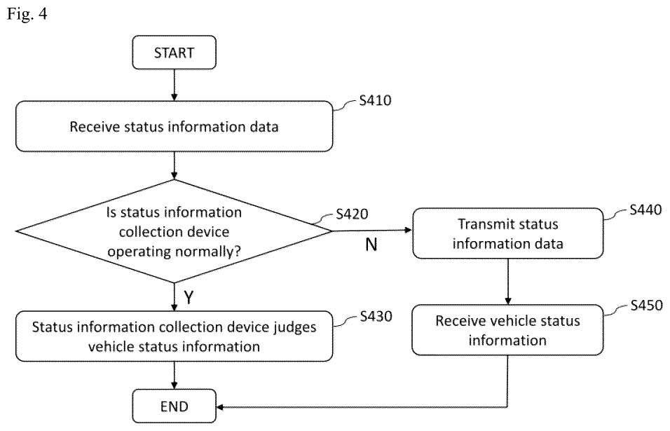

FIG. 4 is a flowchart for explaining a vehicle status monitoring method according to one embodiment of the present disclosure.

The status information collection device 200 according to one embodiment of the present disclosure receives status information data (S410). The status information data may include at least one of component status information data collected from a plurality of sensors installed in a vehicle and sensing data collected while the vehicle is driving.

When the status information collection device 200 is implemented as an electronic control unit, the data may be collected from sensors via CAN communication. Alternatively, when the status information collection device 200 is implemented as physically separate hardware, the data may be received from the electronic control unit.

Then, whether the status information collection device 200 is operating normally is determined (S420). Determining whether the status information collection device 200 is operating normally means determining whether the status information collection device 200 can normally perform an operation of judging the status information of the vehicle using the collected data.

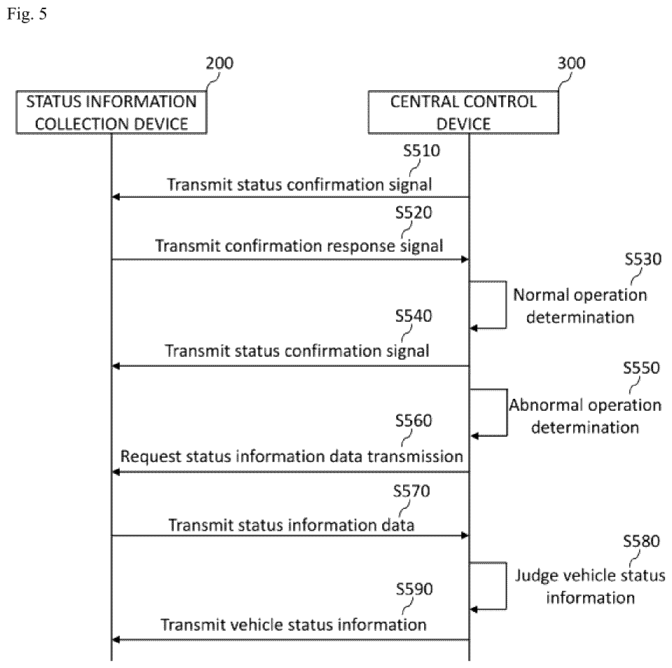

A specific method of determining whether the status information collection device 200 is operating normally will be described in detail with reference to FIGS. 5 to 7.

If it is determined that the status information collection device 200 is operating normally, the status information collection device 200 judges the status information of the vehicle and outputs the judgment result (S430). If it is determined that an abnormal event has occurred in the vehicle, the status information collection device 200 may output the judgment result in the form of generating a fault code corresponding to the occurrence of the abnormal event. Alternatively, the judgment result may be output in the form of performing at least one of turning on a warning light, outputting a warning message, starting a maintenance operation, and initializing the system to notify the driver of the occurrence of the abnormal event.

If it is determined that the status information collection device 200 is operating abnormally, the status information collection device 200 transmits status information data to an outside (S440).

In this case, the outside means a device that is physically or logically separated from the status information collection device 200 equipped in the vehicle. Preferably, the status information collection device 200 may transmit status information data to the central control device 300 connected thereto through a network.

Then, the status information collection device 200 receives vehicle status information from the central control device 300 (S450). That is, vehicle status information judgment is performed by the central control device 300, not the status information collection device 200, and the status information collection device 200 only receives the judgment result.

Accordingly, it is possible to monitor the vehicle status information even when a failure occurs in the status information collection device 200 equipped in the vehicle.

FIG. 5 is a diagram for explaining a method for determining whether a failure has occurred in the status information collection device according to one embodiment of the present disclosure.

In order to determine whether the status information collection device 200 is operating normally, the central control device 300 transmits a status confirmation signal to the status information collection device 200 (S510). In FIG. 5, the central control device 300 is illustrated as directly transmitting the status confirmation signal to the status information collection device 200, but the central control device 300 may also be implemented in a form of transmitting the status confirmation signal to the electronic control unit of the vehicle that is physically or logically separated from the status information collection device 200.

Upon receiving the status confirmation signal, the status information collection device 200 transmits a confirmation response signal to the central control device 300 (S320). According to another embodiment of the present disclosure, the confirmation response signal may be transmitted by the electronic control unit of the vehicle that is physically or logically separated from the status information collection device 200.

When receiving the confirmation response signal, the central control device 300 determines that the status information collection device 300 is operating normally (S530).

Meanwhile, the central control device 300 may transmit the status confirmation signal at preset time intervals or whenever a preset event occurs to transmit the status confirmation signal again (S540).

If a confirmation response signal is not received within a preset time from the time the status confirmation signal is transmitted, or if a confirmation response signal is not received after transmitting the status confirmation signal more than a preset number of times, the central control device 300 determines that a failure has occurred in the status information collection device 200 (S550).

If it is determined that a failure has occurred in the status information collection device 200, the central control device 300 requests the status information collection device 200 to transmit status information data (S560). Alternatively, the central control device 300 may request the electronic control unit equipped in the vehicle to transmit status information data.

In this case, the central control device 300 may also transmit a control signal to stop the operation of judging the vehicle status information to the status information collection device 200 or the electronic control unit.

The central control device 300 receives the status information data from the status information collection device 200 or the electronic control unit (S570), judges the status information of the vehicle (S580), and transmits the result to the status information collection device 200 or the electronic control unit (S590). Optionally, the central control device 300 may store the status information of the vehicle in a storage unit provided in the central control device 300 or transmit it to a user terminal device (not shown).

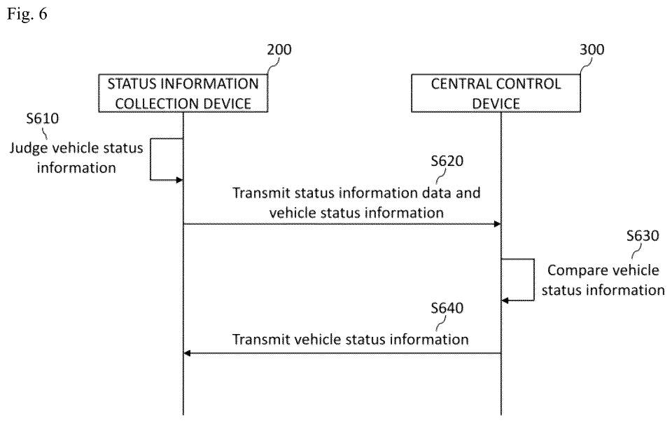

FIG. 6 is a diagram for explaining a method for determining whether a failure has occurred in the status information collection device 200 according to another embodiment of the present disclosure.

The status information collection device 200 judges status information of a vehicle using status information data (S610). Then, the status information collection device 200 transmits the status information data and the vehicle status information judged using the status information data to the central control device 300 (S620).

The central control device 300 judges the vehicle status information using the status information data received from the status information collection device 200 and compares it with the vehicle status information received from the status information collection device 200 (S630).

If the vehicle status information judged by the status information collection device 200 and the vehicle status information judged by the central control device 300 are different, it is determined that a failure has occurred in the status information collection device 200.

In addition, if the vehicle status information judged by the status information collection device 200 and the vehicle status information judged by the central control device 300 are different, the vehicle status may be determined based on the vehicle status information judged by the central control device 300.

In other words, if the vehicle status information judged by the status information collection device 200 and the vehicle status information judged by the central control device 300 are different, despite using the same status information data, the vehicle status information is determined based on the judgment result by the central control device 300.

The central control device 300 transmits the determined vehicle status information to the status information collection device 200 (S640). The vehicle status information determined by the central control device 300 may be stored in a storage unit provided in the central control device 300 or may also be transmitted to a user terminal device (not shown).

In addition, the central control device 300 may further transmit a control signal to the status information collection device 200 to stop the operation of judging the vehicle status information. Upon receiving the control signal, the status information collection device 200 stops the operation of judging the vehicle status information and transmits only the status information data to the central control device 300.

Meanwhile, in the embodiments shown in FIGS. 5 and 6, it is described as an example that the remote central control device 300 determines whether a failure has occurred in the status information collection device 200, but it is also possible to implement the status information collection device 200 so that it can autonomously determine whether a failure has occurred.

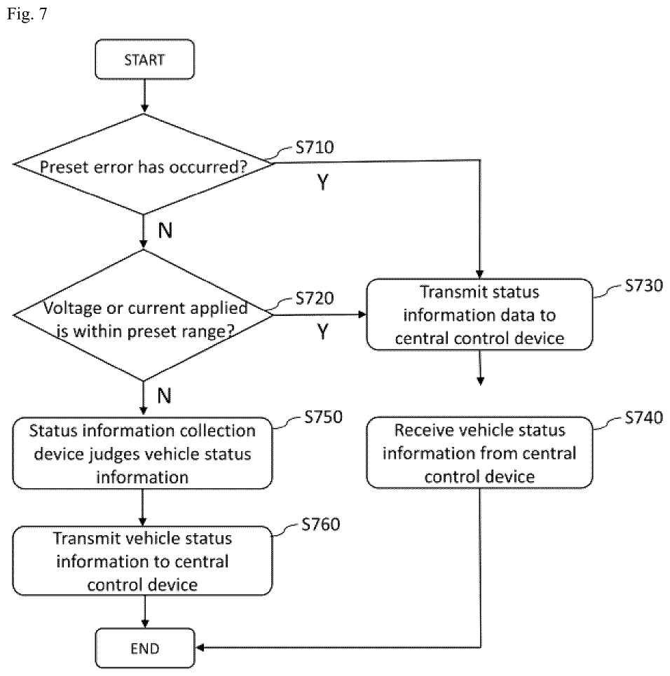

FIG. 7 is a diagram for explaining a method for determining whether a failure has occurred in the status information collection device 200 according to still another embodiment of the present disclosure.

The status information collection device 200 according to one embodiment of the present disclosure may autonomously determine whether a failure has occurred, at preset time intervals or when a preset event occurs.

To autonomously determine whether a failure has occurred, the status information collection device 200 checks whether a preset error has occurred (S710). Specifically, if a pre-stored error code has occurred, it can be determined that a failure has occurred in the status information collection device 200.

It is also possible to detect the occurrence of a failure by judging whether the voltage or current applied to the status information collection device 200 is out of a preset range (S720). In FIG. 7, it is illustrated that the judgment of whether a preset error has occurred and the determination of the magnitude of the applied voltage or current are performed sequentially, but this is exemplary, and the judgment order may be changed or the judgment method illustrated in FIG. 7 may be selectively selected to determine whether a failure has occurred.

If it is determined that a failure has occurred in the status information collection device 200 as a result of the judgment, status information data is transmitted to the central control device (S730). Additionally, the vehicle status information judgment operation by the status information collection device 200 may be stopped. Then, the status information collection device 200 receives the vehicle status information judged by the central control device 300 (S740).

If it is determined that the status information collection device 200 is operating normally based on the judgment result in at least one of steps S710 and S720, the status information collection device 200 judges the status information of the vehicle (S750) and status information 300 (S760).

While all of the components constituting the embodiments of the present disclosure have been described above as being combined or operating in combination, the technical idea of the present disclosure is not necessarily limited to such embodiments. That is, within the scope of the purpose of the present disclosure, all of the components may be selectively combined in one or more combinations to operate.

Although the operations are depicted in the drawings in a specific order, it should not be understood that the operations are necessarily performed in the specific order depicted or in any sequential order, or that all depicted operations are required to achieve a desired result. In certain situations, multitasking and parallel processing may be advantageous. Furthermore, the separation of the various components in the embodiments described above should not be understood to imply that such separation is necessary, and it should be understood that the program components and systems described may generally be integrated together in a single software product or packaged as multiple software products.

While the embodiments of the present disclosure have been described with reference to the accompanying drawings, those skilled in the art to which the present disclosure pertains will understand that the present disclosure may be implemented in other specific forms without changing the technical ideas or essential features thereof. Therefore, the embodiments described above should be understood as illustrative rather than limiting in all respects. The protection scope of the present disclosure should be interpreted by the following claims, and all technical ideas within a scope equivalent thereto should be interpreted as being included in the scope of the technical ideas defined by the present disclosure.

1. A vehicle status monitoring method comprising:
receiving status information data;
determining whether a status information collection device is operating normally or abnormally; and
outputting a result of judging status information of a vehicle using the status information data when it is determined that the status information collection device is operating normally, and transmitting the status information data to an outside when it is determined that the status information collection device is operating abnormally.

2. The vehicle status monitoring method of claim 1, wherein the receiving of the status information data includes receiving at least one of component status information data and sensing data collected while the vehicle is driving.

3. The vehicle status monitoring method of claim 1, further comprising:
transmitting the status information data to the outside and receiving status information of a vehicle from the outside when it is determined that the status collection device is operating abnormally.

4. The vehicle status monitoring method of claim 1, wherein the transmitting the status information data to the outside when it is determined that the status collection device is operating abnormally, includes:
receiving at least one of a status information data request signal and a vehicle status information judgment operation control signal from the outside; and
transmitting the status information data to the outside.

5. The vehicle status monitoring method of claim 4, further comprising:
stopping an operation of judging the status information of the vehicle.

6. The vehicle status monitoring method of claim 1, wherein the transmitting the status information data to the outside when it is determined that the status collection device is operating abnormally, includes stopping an operation of judging the status information of the vehicle and transmitting the status information data to the outside when a preset error occurs in the status information collection device or when a voltage or current applied to the status information collection device is out of a preset range.

7. A vehicle status monitoring system including a status information collection device and a central control device equipped in a vehicle, wherein:
the status information collection device outputs a result of judging status information of the vehicle based on status information data of the vehicle when the condition information collection device is normal, and
the central control device outputs a result of judging status information of the vehicle based on the status information data of the vehicle when the status information collection device is abnormal.

8. The vehicle status monitoring system of claim 7, wherein the central control device transmits a status information data request signal and a vehicle status information judgment operation control signal to the status information collection device when the status information collection device is abnormal.

9. The vehicle status monitoring system of claim 8, wherein the vehicle status information judgment operation control signal is a control signal to stop an operation of judging the status information of the vehicle.

10. The vehicle status monitoring system of claim 7, wherein the central control device transmits a status confirmation signal to the status information collection device, and determines that a failure has occurred in the status information collection device when a confirmation response signal is not received from the status information collection device within a preset time or when a confirmation response signal is not received even after transmitting the status confirmation signal more than a preset number of times.

11. The vehicle status monitoring system of claim 7, wherein the central control device determines that a failure has occurred in the status information collection device when the vehicle status information judged by the status information collection device and the vehicle status information judged by the central control device are different.

12. The vehicle status monitoring system of claim 11, wherein the central control device determines a status of the vehicle based on the vehicle status information judged by the central control device when the vehicle status information judged by the status information collection device is different from the vehicle status information judged by the central control device.

13. The vehicle status monitoring system of claim 12, wherein the central control device transmits the vehicle status information judged by the central control device to the status information collection device.

14. The vehicle status monitoring system of claim 7, wherein the status information collection device transmits the status information data to the central control device when a preset error code occurs and stops the vehicle status information judgment operation.

15. The vehicle status monitoring system of claim 7, wherein when a voltage or current applied to the status information collection device is out of a preset range, the status information collection device transmits the status information data to the central control device and stops the vehicle status information judgment operation.
